(19) United States
(12) Patent Application Publication
(10) Pub. No.: US 2015/0298441 A1
(43) Pub. Date: Oct. 22, 2015

(54) SANDWICH MATERIAL

(71) Applicant: INNVENTIA AB, Stockholm (SE)

(72) Inventors: Fredrikä BERTHOLD, Djursholm (SE); Mikael LINDSTRÖM, Saltsjö-Duvnäs (SE); Åke NYLINDER, Hovås (SE); Hjalmar GRANBERG, Norrköping (SE); Heikki Juhani SOJAKKA, Markaryd (SE); Marie claude BÉLAND, Stockholm (SE)

(21) Appl. No.: 14/648,688

(22) PCT Filed: Dec. 2, 2013
(86) PCT No.: PCT/EP2013/075250

§ 371 Date: May 29, 2015

(30) Foreign Application Priority Data
Nov. 30, 2012 (SE) 1251357-8

(51) Int. Cl. B32B 27/36; B32B 15/20; B32B 37/12; B32B 37/06; B32B 37/10; B32B 5/02; B32B 37/18

(52) U.S. Cl. CPC B32B 27/365; B32B 5/024; B32B 15/20; B32B 37/18; B32B 37/06; B32B 37/10; B32B 37/1207; B32B 2307/202; B32B 2262/04; B32B 2307/738; B32B 2255/00; B32B 2607/00; B32B 2037/1215; B32B 2311/30

(57) ABSTRACT

A sandwich material includes at least 3 layers: a first cover layer, an intermediate layer, and a second cover layer. The intermediate layer is in the form of at least one segmented sheet and includes a mixture of polymer and cellulose fibers. The sheet may include susceptors. Several processes can be used for manufacturing the sandwich material.

### FIELD OF INVENTION

The present invention relates to sandwich materials and in particular to formable sandwich materials, as well as to a method for manufacturing thereof and a method of bending or forming the sandwich material.

### BACKGROUND

Sandwich materials (also commonly known as “sandwich structured composites”) is a class of composite materials consisting of two thin and stiff cover layers and a lightweight but thick intermediate layer (also known as “core”).

The material of the intermediate layer is normally a low strength material. However, the higher thickness thereof provides the sandwich material with high bending stiffness and overall low density.

Foam, balsa wood, syntactic foam, and honeycomb are materials commonly used in the intermediate layer. Glass or carbon fibre reinforced laminates are widely used as cover layers.

Sheet metal has also found use as cover layer material. Metal composite material (MCM) is such a sandwich material, having two cover layers bonded to a plastic intermediate layer.

It is well known that sandwich materials such as the above are commonly difficult to form. Attempts at forming commonly results in breakage and dis-adherence of the constituent parts of the sandwich material.

Moreover, sandwich materials having a polymer comprised in the intermediate layer will necessitate heating of the material prior to, during or after forming, depending on the particular polymer. It is well known in the art that such heating is time consuming and commonly leads to a cumbersome industrial forming process.

Hence, there is a need for more easily formable sandwich materials.

### SHORT DESCRIPTION OF THE FIGURES

FIG. 1 depicts a perspective view of the sandwich material with cover layers (1 and 2) and the intermediate layer (3) consisting of individual sheets (4) with segmentations (5). Susceptors (6) are present in individual sheets (4) of the intermediate layer (3), as well as between the sheets (4).

FIG. 2 depicts a side view of the sandwich material with overlapping segmentations (5). Susceptors (6) are present in individual sheets (4) of the intermediate layer (3), as well as between the sheets (4).

FIG. 3 depicts a top view of the intermediate layer (3). Segmentations (5) are interrupted to retain material strength.

FIG. 4 depicts a top view of the intermediate layer (3) with segmentations (5) that overlap each other sideways, to retain material strength.

FIG. 5 depicts a side view of the sandwich material after forming. The segmentations (5) facilitate forming and reduce the risk for material collapse. Susceptors (6) are present in individual sheets (4) of the intermediate layer (3), as well as between the sheets (4).

FIG. 6 depicts a top view of the intermediate layer (3) with curved segmentations (5) facilitating 3-dimensional forming of the sandwich material.

FIG. 7 depicts a perspective view of the sandwich material with cover layers (1 and 2) and the intermediate layer (3) consisting of individual sheets (4). Susceptors (6) are present in individual sheets (4) of the intermediate layer (3).

FIG. 8 depicts a perspective view of the sandwich material with cover layers (1 and 2) and the intermediate layer (3) consisting of individual sheets (4). Susceptors (6) are present between sheets (4) of the intermediate layer (3).

### DESCRIPTION OF THE INVENTION

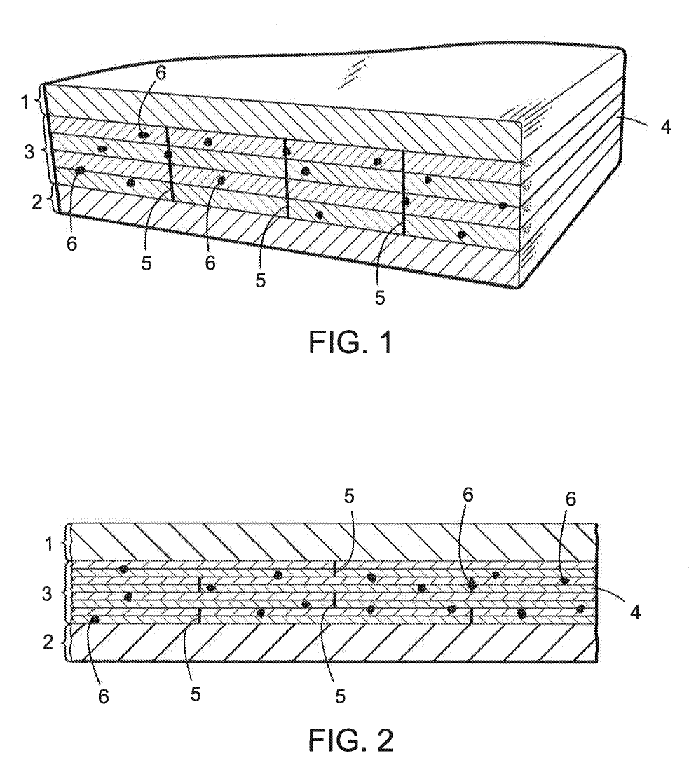

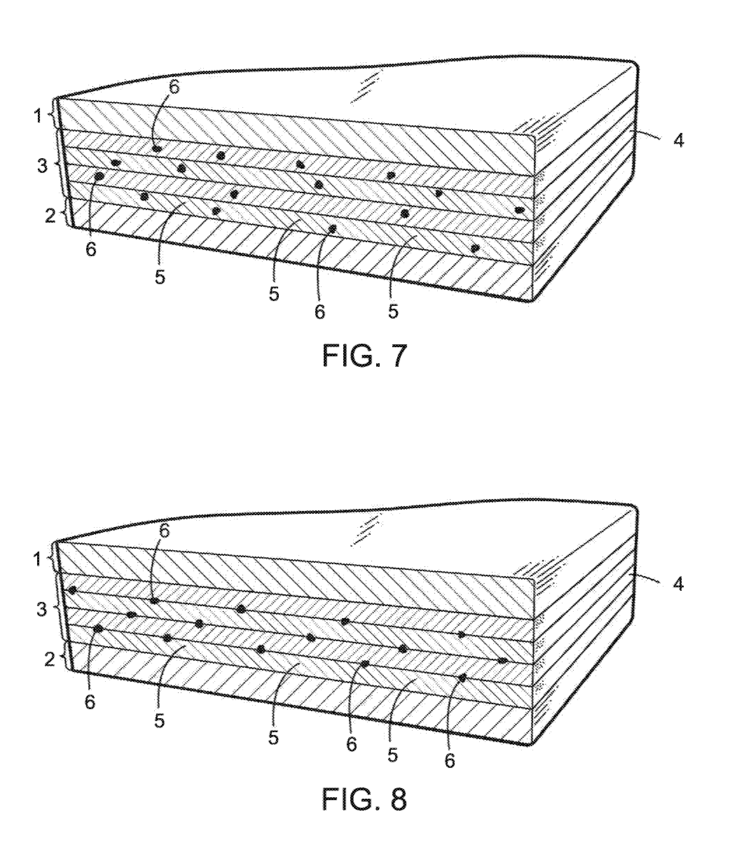

In accordance with the present invention, there is in a first aspect provided a sandwich material comprising at least 3 layers constituted by a first cover layer, an intermediate layer, and a second cover layer. The intermediate layer (sometimes also referred to as “core”) is in the form of at least one sheet and comprises a mixture of at least one polymer and cellulose fibres. The at least one sheet comprises particulate susceptors, and/or particulate susceptors are present between the sheets (see FIGS. 1-2, 5, 7-8; the susceptors denoted 6). In the latter case, susceptors may be present in a glue used during manufacture.

The susceptors absorb electromagnetic energy (e.g. microwaves, induction heating) and are thereby heated. By way of heat, thermoplastic polymers, which may make up part of the intermediate layer, soften. This may be made use of during forming of the sandwich material, e.g. 3-dimensional forming, or during pre-conditioning of the sandwich material. By heating the material, forming is facilitated and the risk of cover layer dis-adherence reduced. As to thermoset polymers, which may also make up part of the intermediate layer, heating facilitates polymer cross-binding after forming.

By the use of susceptors, heating of the material becomes efficient and even, i.e. heat reaches all sites of the material at the same time. This is important for processing economics and also improves material processability. Moreover, material quality is improved.

The susceptors may take a variety of forms, such as fibers, flakes, powders. The dimensions of the individual susceptor are chosen to fit the specific purpose and heating application. As an example, an iron fiber to be mixed with cellulose fibers and polymer, for subsequent forming as a sheet, would ideally be 1-5 mm long and 10-50 μm thick.

The susceptors may be of a material chosen from the group consisting of graphite, carbon, molybdenum, silicon carbide, stainless steels, niobium, aluminum. Any other conductive material may also be made use of. The susceptors may each be 1-5 mm long and 10-50 μm thick, or have a circumference of 1-5 mm.

The intermediate layer of the sandwich material may consists of 2-100 sheets, 10-20 sheets, or 4-10 sheets.

The intermediate layer may be provided as a gradient, e.g. by the sheets containing a varying amount of the at least one polymer. Consequently, the polymer content may be the highest in the sheet(s) adjacent to the cover layers, to improve adherence thereto.

At least one of said sheets may moreover be woven. This may increase the bulk of the sandwich material, and hence its bending stiffness.

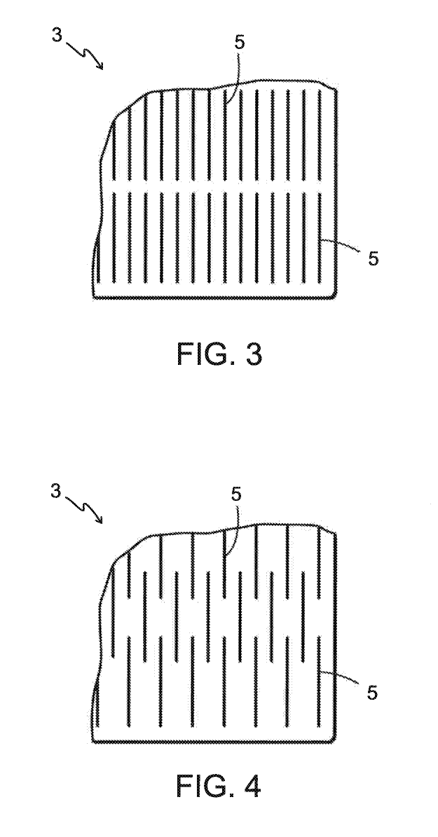

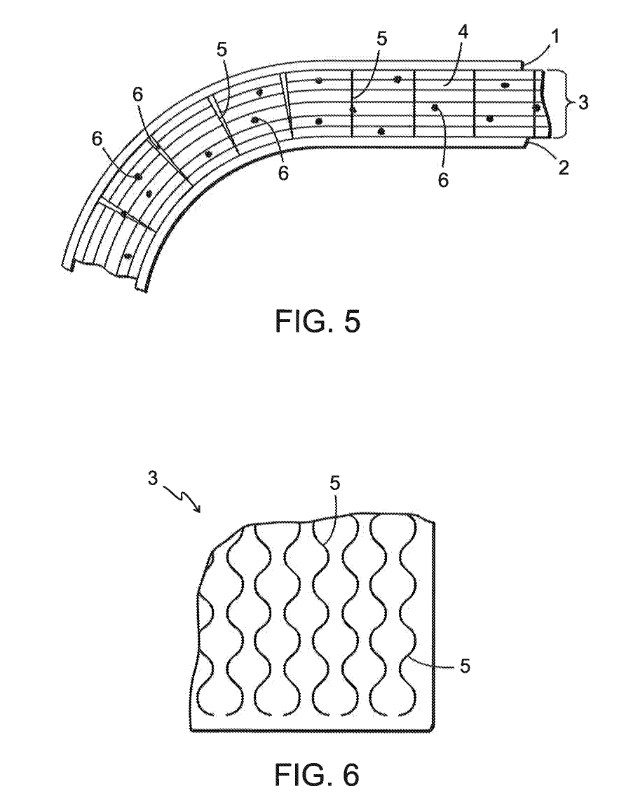

The intermediate layer may be segmented, which segmentation facilitates forming of the sandwich material, and counter-acts forming-induced dis-adherence between the constituent parts of the sandwich material. Hence, segmentation improves material strength. Segmentation may be achieved by stacking sheets, or cutting a stack of sheets (see FIG. 1). Sheets may be overlapping, to improve material strength (see FIG. 2). Advantageously, there are areas of the sheets not cut through, to improve material strength (see FIGS. 3 & 4). In use, the segmentations facilitate forming of the sandwich material, e.g. bending (see FIG. 5). To further improve 3-dimensional forming, the sheets may be segmented (usually cut) in any suitable shape commensurate with the 3-dimensional shape of the sandwich material to be realized.

The cellulose fibres may consists of chemically and/or geometrically modified cellulose fibres in an amount of 1-100% of the total cellulose fibre content.

Cellulose fibres as used herein refers to fibrous material generally derived from, but not limited to, natural sources such as annual plants and wood. Examples of cellulose fibres are bleached and unbleached sulfate fibres, bleached and unbleached sulfite fibres, thermomechanical pulp (TMP) fibres, chemo-thermomechanical pulp (CTMP) fibres, or any other fibre extracted from wood or annual plants using an industrial or industrial like process. The cellulose fibres may moreover constitute regenerated cellulose, partly or exclusively.

Examples of annual plants are Kenaf, Coconut, Corn, Soybean, Cotton, Jute, Sisal, Hemp, Flax and different grasses.

The exact chemical composition of the cellulose fibres in the material according to the invention will depend on both the raw material and the extraction procedure used. The main constituent parts of cellulose fibres are cellulose, hemicellulose and lignin. The term “cellulose fibres” as used herein is also intended to encompass man-made, cellulose-derived fibres, such as Viscose and Lyocell.

The term “geometrically modified” is used herein as meaning any treatment of fibrous cellulose fibres with the aim to alter the geometry of said cellulose fibres. A listing of treatments include, but are not limited to, grinding, milling, crushing, beating, shredding, ultra sound treatment and homogenization.

Geometrically modified cellulose fibres, having altered aspect ratio, size and/or structure, are used to improve properties such as binding ability to polymer(s) and/or other fibres, reactivity, stability and structural homogeneity. Use of strongly modified cellulose fibres having very high Shopper Riegler value(s) is preferred (see below).

The above treatments may be combined with chemical modification of the cellulose fibres (herein understood as also encompassing physical and/or biochemical modification). Alternatively, chemical modification of the cellulose fibres may be carried out as the sole mode of modification. Reasons for chemical modification of the cellulose fibres are to impart the cellulose fibres with altered mechanical properties, altered surface properties, altered bioactivity, color, ease of subsequent geometrical modification, and altered aging properties.

The geometrically modified cellulose fibres of the intermediate layer may comprise or consist of micro fibrillated cellulose, i.e. cellulose wherein single so-called cellulose fibrils have been liberated from the cellulose fiber. Microfibrillated cellulose may improve mechanical properties of the sandwich material, increase thermal stability thereof and alter the crystallization behavior of the matrix, by e.g. acting as a nucleating agent. Microfibrillated cellulose and a method for manufacturing thereof have been disclosed in e.g. EP 1984561.

One common way to describe how comprehensively a cellulose fibre has been geometrically modified is its de-watering behavior. This can be assessed by e.g. Shopper-Riegler measurements. This test will give a value describing the ease of dewatering of a bat of the cellulose fibres to be studied. The value is empirical and no direct correlation between the Shopper-Riegler value and exposed cellulose surface exist. However, within a given type of cellulose fibres, the value can be used to describe the extent of geometrical modification.

The geometrically modified cellulose fibres of the sandwich material may comprise or consist of wood derived cellulose fibres having a Shopper-Riegler number from 100 to 500. In a ninth embodiment, said Shopper-Riegler number is in the interval of from 50 to 100, whereas the Shopper-Riegler number in an tenth embodiment is in the interval of from 10 to 50.

Another way of illustrating geometrical modification is by using the so-called water retention value (WRV), which is a measurement more related to the internal structure of cellulose fibers, as compared to Shopper-Riegler values. In accordance with the invention, the geometrically modified cellulose fibres may have WRV values in the interval of from 25 to 95, e.g 2-25, and alternatively 0.5-5.

Different types of chemically and/or geometrically modified fibers may be mixed with each other and/or with unmodified fibers to achieve advantageous properties of the final mixture with regard to e.g. mechanical properties, hygroscopic and hydroscopic properties, binding properties, interaction with polymeric matrix, long-term properties during end use, gas permeability properties and influence on the molecular organization of the chosen polymeric matrix.

The chemical nature of the cellulose fibres can also be altered through chemical modification. There are numerous reasons why it is of interest to use chemically modified cellulose fibres in a sandwich material according to the invention. A non-limiting list of reasons would include altered mechanical properties, altered surface properties, modified interaction with water and moisture, altered bioactivity, altered color, and altered aging properties.

The chemically modified cellulose fibres of the sandwich material may have been modified by way of hydrofobization, heat treatment and/or covalent cross-binding so as to render the fibres more stable against water uptake and swelling. Moreover, the effected changed surface properties may improve interaction with the polymer of the intermediate layer. Modification of fibre pH may moreover render the intermediate layer more stable.

The polymer of the sandwich material may be a thermoplastic polymer or a thermoset polymer, or a combination thereof. The constituent polymer(s) made use of depend on the characteristics sought to be achieved by sandwich material.

A by no way complete list of examples of properties and process conditions that depend on the choice of thermoplastic polymer(s) and/or thermoset polymer(s) are thermal stability, chemical stability, mechanical properties, moldability, and joint strength, The combination of thermoplastics and thermosets can influence several properties, e.g long term stability, water uptake/swelling and mechanical properties.

The thermoplastic polymer may be chosen from the group consisting of polyesters, polyolefins, and bio-based thermoplastic polymers. Bio-based thermoplastic polymers distinguish themselves from other polymers in that they are produced from renewable resources such as carbohydrates and vegetable oils. In one alternative, the thermoplastic polymer is not a polyolefin.

Specifically, the thermoplastic polymer may be chosen from the group consisting of polylactic acid (PLA), derivative(s) thereof and mixtures of polylactic acid and derivative(s) thereof. The nature of the PLA with regard to e.g polymer architecture, tacticity, molecular weight, monomer unit composition and type of end groups will influence many properties of the sandwich material. Examples of properties that can be influenced are the interfacial strength both between intermediate layer and cover layers, as well as between cellulose fibres and matrix in the intermediate layer. Moreover, the heat deflection temperature (HDT), rate of aging under different conditions and mechanical properties such as stiffness and strength would be affected by the choice of polymer quality.

The intermediate layer may comprise a thermoset polymer chosen from the group of a polyester, vinyl ester, epoxi polymer, polyurethane, lignin or lignin derivative. The polyester or epoxi polymer may be a resin with high heat resistance, enabling the use of high manufacturing temperatures. Moreover, high heat resistance would allow the sandwich material to be exposed to high temperatures, during end use.

In addition to cellulose fibres and polymer, the intermediate layer may comprise additives to bring forth advantageous properties, such additives being exemplified by e.g. flame retardants, herbicides, chemical stabilizers, UV-absorbents or any other component deemed important for satisfactory performance of the intermediate layer during manufacture and/or use of the sandwich material (including bending and forming).

The sandwich material may further contain conductive layer(s) or structure(s) for signal transduction, energy transport or for facilitating bending/deformation of the sandwich material. The conductive layer(s) or structures may be in the form of printed patterns, films or other printable structures on at least one sheet of the intermediate layer, whereby the ink has conductive properties. A conductive layer may alternatively be in the form of a film containing conductive particles such as carbon, in various forms. Conductivity metal foil(s) and/or or metal threads, or other conductive bodies may moreover form constituent parts of the conductive layer(s) or structure(s).

By tuning the resistance of the conductive layer(s) or structure(s) transfer of heat into the material is enabled, and local heating of the material is made possible, before bending or forming of the material. Local heating and subsequent deformation may moreover facilitate the removal of e.g. inaccessible spare parts.

The sandwich material may comprises an open internal structure. Such an open structure may facilitate the exit of gases during manufacturing, and hence minimize the advent of free gas bubbles in the intermediate layer of the sandwich material. The open structure may be created by altering the relative composition of the intermediate layer, allowing the fibres to create a scaffold through which the gases that would otherwise become entrapped can exit the material during consolidation, i.e. during assembly and heat pressing. Unexpectedly, even when there are no voids in the intermediate layer, the cellulose fibres, being relatively open and porous, will allow for gases to escape the interior of the material. Entrapped gas bubbles may have a strong negative influence on the end properties of the sandwich material, and hence the possibility for gases to exit the material results in a superior sandwich material.

Said open structure may be delimited by a mixture of microfibrillated cellulose and polylactic acid, and/or derivative(s) thereof. This delimitation would create a barrier hindering gases from freely moving into and through the intermediate layer once the sandwich material is manufactured, whereby the intermediate layer and the sandwich material is protected from external influence by e.g. moisture and water.

The first and second cover layers of the sandwich material may be chosen from the same or different materials from the group consisting of steel, stainless steel, aluminum, titanium, copper, zinc, magnesium, and alloys thereof, and fibre-reinforced polymer, polycarbonate, carbon fibre-based mat. Hence, there is provided a sandwich material which is considerably lighter than e.g. conventional metal sheets. Due to its strength and low weight, the sandwich material according to the invention may be used for e.g. constructive purposes, as paneling, backing for furniture or as sign plate.

The first and second cover layers may also be machined so that they contain holes, groves, slits or other openings. Furthermore, the first and second cover layers can be modified using embossing or striking to impart patterns and structure. When appropriate, the first and second cover layers may be painted or surface modified before assembly. Moreover, the first and second cover layers may be machined into a predetermined form prior to assembly of the sandwich material.

The first and second cover layers of the sandwich material may each have a thickness in the interval from 0.01 to 1 mm, and the intermediate layer may have a total thickness in the interval from 0.3 to 15 mm.

The first and second cover layers of the sandwich material may alternatively each have a thickness in the interval from 0.05 to 0.3 mm, with the intermediate layer having a total thickness in the interval from 0.5 to 2 mm.

In a second aspect of the invention, there is provided a process for manufacturing a sandwich material, comprising
(a) mixing at least one thermoplastic or thermoset polymer in solid or liquid form with cellulose, the cellulose optionally comprising or consisting of chemically and/or geometrically modified cellulose fibres;
(b) spreading out the mixture, either in wet or dry form, to form a sheet;
(c) pre-conditioning the sheet;
(d1) simultaneously assembling and heat pressing one or more sheets formed in (a)-(c) in between two cover layers, whereby sheets may be overlapping, and glue may be made use of; or alternatively
(d2) assembling and heat pressing one or more of the sheets formed in (a)-(c) onto a first cover layer, whereby the sheets may be overlapping, whereupon a second cover layer is assembled and heat pressed onto the side of the at least one sheet opposite the first cover layer, whereby glue may be used during the assembly;
whereby susceptors are added to the mixture in (a) and/or to the glue in (d1) or (d2).

In a third aspect of the invention, there is provided a process for manufacturing a sandwich material, comprising
(a) provision of a pre-formed cellulose sheet, optionally comprising or consisting of chemically and/or geometrically modified cellulose fibres;
(b) adding at least one thermoplastic or thermoset polymer onto the pre-formed sheet, by way of e.g. spraying or dipping the sheet;
(c) pre-conditioning the sheet;
(d1) simultaneously assembling and heat pressing one or more sheets formed in (a)-(c) in between two cover layers, whereby sheets may be overlapping, and glue may be made use of; or alternatively
(d2) assembling and heat pressing one or more of the sheets formed in (a)-(c) onto a first cover layer, whereby sheets may be overlapping, whereupon a second cover layer is assembled and heat pressed onto the side of the at least one sheet opposite the first cover layer, whereby glue may be used during assembly;

whereby susceptors are added to the mixture in (a) and/or to the glue in (d1) or (d2).

In (d1) and (d2) above, assembly is carried out at an elevated temperature. The elevated temperature is advantageously the melting temperature of the chosen polymer ±30° C. The temperature is chosen in relation to the at least one polymer, or alternatively one of the polymers. If several different polymers are present, the heat pressing temperature is chosen in relation to at least the lowest melting temperature of the polymers present.

Alternatively, if the chosen polymeric matrix is amorphous and does not exhibit any distinct melting point, the temperature in (d1) and (d2), respectively, is equal to or exceeds the tackiness point of the polymer(s). If the polymer is chosen from the group of thermoset polymers, e.g. epoxy or vinyl ester resins, the temperature is chosen so that cross-linking is initiated in (d1) and (d2), respectively.

The polymer(s) used would affect the solvent to be used during manufacture, for the polymer in liquid form, as well as process conditions during manufacture and choice of cellulose.

Pre-conditioning should be understood to mean either drying or re-wetting sheet(s) using methods known in the art to reach suitable moisture (i.e. water) content in the intermediate layer before assembly of the constituent parts of the sandwich material. The amount of moisture in the intermediate layer should preferably be between 0 and 15% by weight of the sheet(s). The pre-conditioning step also allows ripening, to attain an easily processable sheet.

Sheets may moreover be segmented. Segmenting (e.g. cutting) of sheets may be performed either before or after the pre-conditioning.

The polymer may be provided in solid form, e.g. as fibres, powders, flakes, particles, latexes. The polymer may alternatively be added in liquid form (as suspension , solution or melt) or through spraying, dipping, dropping, electrospinning or any other technique known in the art.

The sheet(s) of the intermediate layer of the sandwich material may be manufactured using wet forming or dry forming technique.

In wet forming a sheet is formed in a solvent, commonly water. Examples of wet forming are the production of ordinary writing paper, newspaper and paperboard.

In dry forming, a sheet is formed in the absence of a solvent. Examples of dry forming systems are random air-laid, carded web systems and spun lace systems.

The sandwich material may be assembled using polylactic acid, and/or derivative(s) thereof, as glue. Said polylactic acid, and/or derivative(s) thereof, may be used in and between the individual sheets of the intermediate layer, as well as for assembling the cover layer(s) onto the intermediate layer. No additional glue needs to be added.

The sandwich material may be allowed to assume a temperature below the melting point for the at least one polymer, under pressure.

The geometrically modified cellulose fibres in (a) may comprise or consist of microfibrillated cellulose.

The chemically modified cellulose fibres may have been modified by way of hydrofobization, change of interface strength, or covalent cross-binding, in order to control/decrease dimensional change during manufacture of the sandwich material. Chemical modification of the cellulose fibres may facilitate subsequent geometrical modification of the cellulose fibres.

Geometrical and/or chemical modification treatments may be combined, in a suitable manner, so as to achieve desired properties of treated cellulose fibres.

The susceptors may be of a material chosen from the group consisting of graphite, carbon, molybdenum, silicon carbide, stainless steels, niobium, aluminum. Any other conductive material may also be made use of. The susceptors are not provided as a solid sheet.

The susceptors may take a variety of forms, such as fibers, flakes, powders. The dimensions of the individual susceptor are chosen to fit the specific purpose and heating application. In general, the susceptors may be 1-5 mm long and 10-50 μm thick, or have a circumference of 1-5 mm. As an example, an iron fiber to be mixed with cellulose fibers and polymer, for subsequent forming as a sheet, would ideally be 1-5 mm long and 10-50 μm thick, or have a circumference of 1-5 mm.

The susceptors absorb electromagnetic energy (e.g. microwaves, induction heating) and are thereby heated. By way of heat, the thermoplastic softens. This may be made use of during forming of the sandwich material, e.g. 3-dimensional forming, or during pre-conditioning of the sandwich material. By heating the material, forming is facilitated and the risk of cover layer dis-adherence reduced. As to thermoset polymers, heating facilitates polymer cross-binding.

By the use of susceptors, heating of the material becomes efficient and even, i.e. heat reaches all sites of the material at the same time. This is important for processing economics and also improves material processability. Moreover, material quality is improved.

In a fourth aspect of the invention, there is provided a method of bending or forming a sandwich material as described above, wherein the first and second cover layers retain a distance after said bending or forming. This characteristic is of considerable advantage, since it underlies the possibility to form the material. The geometrically and/or chemically modified cellulose fibres improve slip of the fibres in the intermediate layer during forming. This characteristic of the sandwich material greatly facilitates 3-dimensional forming of the material.

The invention shall now be described with reference to the below example, which illustrates the spirit of the invention and shall not be seen to limit the scope of the invention in any way whatsoever.

### EXAMPLES

Sandwich materials having different core composition with regard to relative cellulose fibre content and choice of polymer have been prepared.

### Example 1

PLA and cellulose fibres (i.e. pulp) containing standard test sheets , essentially produced according to SS EN ISO 5269 were used as core material. When 100% neat polymer was used as core, the polymer was placed between the cover layers either in the form of powder, pellets or fibres. All polymer grades tested where of commercial grade purchased from Natureworks (NatureWorks LLC, 15305 Minnetonka Boulevard, Minnetonka, Minn. 55345, USA) except PLA finers (PLA 01). Both cover layers were constituted by either 0.1 or 0.2 mm stainless steel, respectively.

Panels of the sandwich material according to the invention were prepared as follows:
1. The material to be used as cover layers was cut into 150*150*0.1 (0.2) mm pieces.
2. The glue side of said cover layers was treated with fine emery cloth (grade 30) using straight movements.
3. The cover layers were immersed in an alkaline cleaning solution (Extran AP12, Merk, 0.5 g/l) and treated with ultra sound for 15 minutes.
4. Cover layers were rinsed using tap water.
5. Cover layers were immersed in isopropanol/water 1:1 and yet again treated with ultra sound for 15 minutes. After said treatment, the pieces were stored in the solvent until further use.
6. Right before assembling the sandwich material, the cover layers were taken from the isopropanol/water solution, dried and placed in toluene. After removing the pieces from the toluene they were dried using pressurized air and immediately used in the production of panels to be tested. The panels were always handled with pincers and cotton gloves to prevent contamination.

The panels were placed in an oven set at 210° C. and heated for an appropriate time after which they were rapidly moved to a planar press. The panels were pressed for 4-7 minutes at 180-185C and a pressure of 390-395 bar (on the piston), after which the press was water cooled while the panels were still under pressure.

TABLE 1
Example of observed z-strength of sandwich materials containing
polymer only, tested according to ASTM standard C 297/C297M-04.

| Sample No. | PLA type | PLA structure | Sigmaₘₐₓ, (kPa) |
|---|---|---|---|
| A 01 | 2002D | pellet | 15300 |
| B 01 | 3251D | pellet | 14600 |
| C 01 | 4060D | milled | 14300 |
| D 01 | 8052D | milled | 12500 |
| E 06 | PLA 01 | fibre | 5600 |
| E 07 | PLA 01 | Fibre | 7300 |
| E 09 | PLA 01 | Fibre | 3100 |

The flatwise tensile strength was determined according to ASTM standard C 297/C297M-04 (see tables 1 and 2)

TABLE 2
Examples of observed z-strength of sandwich materials containing
both polymer and cellulose fibres, tested according to ASTM
standard C 297/C297M-04.

| Sample No. | PLA type | PLA (%) | Sigmaₘₐₓ (kPa) |
|---|---|---|---|
| A 2 | 2002D | 40 | 14 700 |
| A 9 | 2002D | 60 | 16 600 |
| B 11 | 3251D | 40 | 16 100 |
| B 17 | 3251D | 60 | 16 800 |
| C 20 | 4060 | 40 | 12 100 |
| C 25 | 4060 | 60 | 15 600 |
| D 29 | 8052D | 40 | 15 700 |
| D 36 | 8052D | 60 | 16 700 |
| E 40¹⁾ | PLA 01 | 50 | 2 400 |
| E 37 | PLA 01 | 40 | 12 200 |
| E 43 | PLA 01 | 60 | 13 100 |
| E 44²⁾ | PLA 01 | 60 | 9 900 |

¹⁾pressed in cold tool;
²⁾polished metal surface

The results presented in tables 1 and 2 clearly indicate that very strong adhesion between the cover layers and the intermediate layer can be achieved without addition of any additional adhesive to the system. In several cases the test setup failed in the trestle-steel joint rather than between the cover layer and the intermediate layer, indicating strong adhesion between the cover layer and the intermediate layer. Unexpectedly, the PLA fibres (PLA 01) gave weaker samples as compared to the other PLA variants tested. An explanation to this can be that these fibres have been treated to handle well in water suspensions. Washing of the fibres prior to use improved the properties, see table 1. These samples were however still weaker compared to the other samples.

Of the tested PLA qualities, 2002D and 3251D seem to give the strongest joints. This is explained as a result of the fact that the fibres can act as conduits allowing air to escape out of the core during pressing, preventing the formation of air pockets that may otherwise act as weak points in a sandwich material. Comparing samples containing 40 and 60 wt % PLA, it is observed that the sandwich becomes stronger when more PLA is used. This is likely the result of more comprehensive wetting of the steel surface at the higher level of PLA.

1. Sandwich material comprising at least the following 3 layers;
(a) a first cover layer
(b) an intermediate layer
(c) a second cover layer,
wherein the intermediate layer is in the form of at least one sheet and comprises
a mixture of at least one polymer and cellulose fibres, and the at least one sheet comprises particulate susceptors and/or particulate susceptors are present between the sheets.

2. Sandwich material according to claim 1, wherein the cellulose fibres consists of chemically and/or geometrically modified cellulose fibres in an amount of 1-100% of the total cellulose fibre content.

3. Sandwich material according to claim 1, wherein the intermediate layer consists of 2-100 sheets.

4. Sandwich material according to claim 3, wherein the intermediate layer consists of 10-20 sheets.

5. Sandwich material according to claim 3, wherein the intermediate layer consists of 4-10 sheets.

6. Sandwich material according to claim 1, wherein the susceptors are of a material chosen from the group consisting of graphite, carbon, molybdenum, silicon carbide, stainless steels, niobium, aluminum.

7. Sandwich material according to claim 1, wherein the susceptors each are 1-5 mm long and 10-50 μm thick, or have a circumference of 1-5 mm.

8. Sandwich material according to claim 1, wherein the sheet(s) of the intermediate layer are segmented.

9. Sandwich material according to claim 8, wherein the segmented sheets are overlapping.

10. Sandwich material according to claim 1, wherein at least one sheet is woven.

11. Sandwich material according to claim 2, wherein the geometrically modified cellulose fibres comprise or consist of micro fibrillated cellulose.

12. Sandwich material according to claim 2, wherein the geometrically modified cellulose fibres comprise or consist of wood derived cellulose fibres having a Shopper-Riegler number from 100 to 500.

13. Sandwich material according to claim 2, wherein the geometrically modified cellulose fibres comprise or consist of wood derived cellulose fibres having a Shopper-Riegler number from 50 to 100.

14. Sandwich material according to claim 2, wherein the geometrically modified cellulose fibres comprise or consist of wood derived cellulose fibres having a Shopper-Riegler number from 10 to 50.

15. Sandwich material according to claim 2, wherein the chemically modified cellulose fibres have been modified by way of hydrofobization, heat treatment, change of interface strength, or covalent cross-binding.

16. Sandwich material according to claim 1, wherein the polymer is a thermoplastic polymer or a thermoset polymer, or a combination thereof.

17. Sandwich material according to claim 16, wherein the thermoplastic polymer is chosen from the group consisting of polyesters, polyolefins, and biobased thermoplastic polymers.

18. Sandwich material according to claim 17, wherein the thermoplastic polymer is chosen from the group consisting of polylactic acid, derivative(s) thereof and mixtures of polylactic acid and derivative(s) thereof.

19. Sandwich material according to claim 16, wherein the thermoset polymer is a polyester, vinyl ester, epoxi polymer, polyurethane, lignin or lignin derivative.

20. Sandwich material according to claim 19, wherein the polyester or epoxi polymer is a resin with high heat resistance.

21. Sandwich material according to claim 1, further containing a conductive layer for signal transduction or for facilitating bending/deformation of the sandwich material.

22. Sandwich material according to claim 1, comprising an open internal structure.

23. Sandwich material according to claim 22, wherein the open internal structure is delimited by a mixture of microfibrillated cellulose and polylactic acid, and/or derivative(s) thereof.

24. Sandwich material according to claim 1, wherein the first and second cover layers are chosen from the same or different materials from the group consisting of steel, stainless steel, aluminum, titanium, copper, zinc, magnesium, and alloys thereof, and fibre-reinforced polymer, polycarbonate, carbon fibre-based mat.

25. Sandwich material according to claim 1, wherein the first and second cover layers each have a thickness in the interval from 0.01 to 1 mm, and the intermediate layer has a total thickness in the interval from 0.3 to 15 mm.

26. Sandwich material according to claim 25, wherein the first and second cover layers each have a thickness in the interval from 0.05 to 0.3 mm, and the intermediate layer has a total thickness in the interval from 0.5 to 2 mm.

27. Process for manufacturing a sandwich material, comprising
(a) mixing at least one thermoplastic or thermoset polymer in solid or liquid form with cellulose, the cellulose optionally comprising or consisting of chemically and/or geometrically modified cellulose fibres,
(b) spreading out the mixture, either in wet or dry form, to form a sheet
(c) pre-conditioning the sheet;
(d1) simultaneously assembling and heat pressing one or more sheets formed in (a)-(c) in between two cover layers, whereby sheets may be overlapping, and glue may be made use of; or alternatively
(d2) assembling and heat pressing one or more of the sheets formed in (a)-(c) onto a first cover layer, whereby the sheets may be overlapping, whereupon a second cover layer is assembled and heat pressed onto the side of the at least one sheet opposite the first cover layer, whereby glue may be used during the assembly;
whereby particulate susceptors are added to the mixture in (a) and/or to the glue in (d1) or (d2).

28. Process for manufacturing a sandwich material, comprising
(a) provision of a pre-formed cellulose sheet, optionally comprising or consisting of chemically and/or geometrically modified cellulose fibres;
(b) adding at least one thermoplastic or thermoset polymer onto the pre-formed sheet,
(c) pre-conditioning the sheet;
(d1) simultaneously assembling and heat pressing one or more sheets formed in (a)-(c) in between two cover layers, whereby sheets may be overlapping, and glue may be made use of; or alternatively
(d2) assembling and heat pressing one or more of the sheets formed in (a)-(c) onto a first cover layer, whereby sheets may be overlapping, whereupon a second cover layer is assembled and heat pressed onto the side of the at least one sheet opposite the first cover layer, whereby glue may be used during the assembly;
whereby particulate susceptors are added to the mixture in (a) and/or to the glue in (d1) or (d2).

29. Process according to claim 27, wherein in (c) the sheet is segmented.

30. Process according to claim 27, wherein in steps (d1) and (d2) polylactic acid, and/or derivative(s) thereof, is used as glue during assembly.

31. Process according to claim 27, wherein as a final step the sandwich material is allowed to assume a temperature below the melting point for the at least one polymer, under pressure.

32. Process according to claim 27, wherein the geometrically modified cellulose fibres in (a) comprise or consist of micro fibrillated cellulose.

33. Process according to claim 27, wherein the chemically modified cellulose fibres have been modified by way of hydrofobization, change of interface strength, or covalent cross-binding.

34. Process according to claim 27, wherein the susceptors are of a material chosen from the group consisting of graphite, carbon, molybdenum, silicon carbide, stainless steels, niobium, aluminum.

35. Process according to claim 27, wherein the susceptors each are 1-5 mm long and 10-50 μm thick, or have a circumference of 1-5 mm.
